(19) United States
(12) Patent Application Publication
(10) Pub. No.: US 2013/0307930 A1
(43) Pub. Date: Nov. 21, 2013

(54) STEREOSCOPIC IMAGE PROCESSING APPARATUS AND METHOD THEREOF

(71) Applicant: Guoping Li, Hefei City (CN)

(72) Inventor: Guoping Li, Hefei City (CN)

(73) Assignee: Mediatek Singapore PTE. Ltd., Singapore (SG)

(21) Appl. No.: 13/982,995

(22) PCT Filed: Nov. 15, 2011
(86) PCT No.: PCT/CN11/82230

§ 371 Date: Jul. 31, 2013

(51) Int. Cl. H04N 13/00

(52) U.S. Cl. CPC H04N 13/0007
USPC 348/43

(57) ABSTRACT

A stereoscopic image processing method is provided. The method comprises the following steps of: receiving a stereoscopic image; shifting the received stereoscopic image according to offset information thereof; and scaling the shifted stereoscopic image to generate a resulting stereoscopic image according to the offset information.

### TECHNICAL FIELD

The present invention relates to stereoscopic image scaling, and in particular relates to a system and method for scaling a stereoscopic image according to the corresponding offset.

### BACKGROUND

Due to developments in digital technologies, a technology for three-dimensionally processing a video image has become more widespread. Since human eyes are separated in a horizontal direction by a predetermined distance, two-dimensional images respectively viewed by the left eye and the right eye are different from each other and thus parallax occurs. The human brain combines the left-eye image and the right-eye image to generate a three-dimensional image that looks realistic. Specifically, there is an offset value for shifting the left-eye image and the right-eye image to generate stereoscopic perception, and the offset value may vary depending on the depth of the objects in the left-eye/right-eye images. For example, when the objects are far away from the user, the offset value (i.e. the parallax) of the left-eye/right-eye image may be very small. When the objects are near the user, the offset value (i.e. the parallax) of the left-eye/right-eye image may be large.

FIG. 1 illustrates a diagram of a conventional stereoscopic image processing method. When an object in a stereoscopic image (i.e. the left-eye image 110 and the right-eye image 120) moves toward (i.e. get closer) the user during the period from time 1 to 4, the offset value for the stereoscopic image should be increased. When the object moves away from the user during the period from time 4 to 7, the offset value for the stereoscopic image should be decreased. However, the size of the stereoscopic image or the object remains unchanged for prior technologies, as illustrated in FIG. 1, and thus it is not easy for the user to sense the object as being realistic.

### SUMMARY

A detailed description is given in the following embodiments with reference to the accompanying drawings.

In one embodiment of the invention, a stereoscopic image processing method is provided. The method comprises the following steps of: receiving a stereoscopic image; shifting the received stereoscopic image according to offset information thereof; and scaling the shifted stereoscopic image to generate a resulting stereoscopic image according to the offset information.

In another embodiment of the invention, a stereoscopic image processing apparatus is provided. The stereoscopic image processing apparatus comprises: an display control unit for receiving a stereoscopic image; an offset processing unit for shifting the received stereoscopic image according to offset information thereof; and a scaling unit coupled to the offset processing unit, for scaling the shifted stereoscopic image to generate a resulting stereoscopic image according to the offset information.

In yet another embodiment, a non-transitory computer-readable medium with an executable program stored thereon is provided, wherein the program instructs a processor to perform the following steps: receiving a stereoscopic image; shifting the received stereoscopic image according to offset information thereof; and scaling the shifted stereoscopic image to generate a resulting stereoscopic image according to the offset information.

### BRIEF DESCRIPTION OF DRAWINGS

The present invention can be more fully understood by reading the subsequent detailed description and examples with references made to the accompanying drawings, wherein:

FIG. 1 illustrates a diagram of a conventional stereoscopic image processing method.

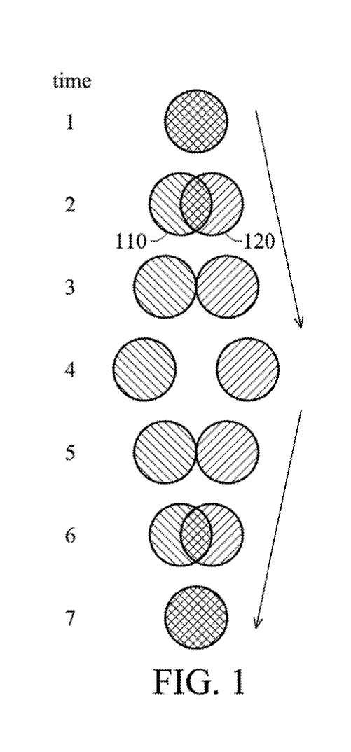

FIG. 2 illustrates a block diagram of the stereoscopic image processing apparatus according to an embodiment of the invention.

FIG. 3 illustrates the structure of offset metadata in the Blu-ray disc specification.

FIG. 4 illustrates a diagram of the conceptual image of plane shifting using the offset value.

FIG. 5 illustrates a diagram for a moving object in the shifted stereoscopic image according to an embodiment of the invention.

FIG. 6 illustrates a flow chart of the stereoscopic image processing method according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

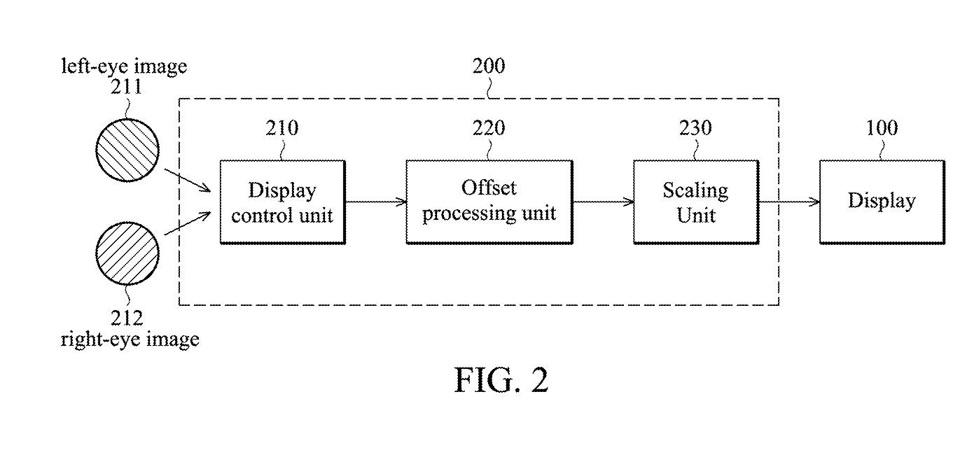

FIG. 2 illustrates the stereoscopic image processing apparatus 200 according to an embodiment of the invention. The stereoscopic image processing apparatus 200 may comprise a display control unit 210, an offset processing unit 220, and a scaling unit 230. The display control unit 210 is capable of receiving a left-eye image 211 and a right image 212 (i.e. a stereoscopic image). The offset processing unit 220 is capable of shifting the left-eye image 211 and the right-eye image 212 according to offset information thereof (i.e. offset value and/or offset direction), respectively, wherein the offset information can be stored in video files in a Blu-ray disc or preset by a user. The scaling unit 230, coupled to the offset processing unit 220, is capable of scaling the shifted left-eye image and the shifted right-eye image (i.e. the shifted stereoscopic image) to generate a resulting stereoscopic image (i.e. the scaled stereoscopic image) according to the corresponding offset information of the left-eye image 211 and right-eye image 212. The scaling unit 230 may further display the resulting stereoscopic image on the display 100 (i.e. display the scaled left-eye/right-eye image alternately). The details for shifting the left-eye/right-eye images will be described in the following sections. In another embodiment, the display function of the scaling unit 230 can be incorporated into an output control unit (not shown in FIG. 2) coupled to the scaling unit 230 alternatively. Accordingly, the output control unit may display the resulting stereoscopic image on the display 100 (i.e. display the scaled left-eye/right-eye image alternately).

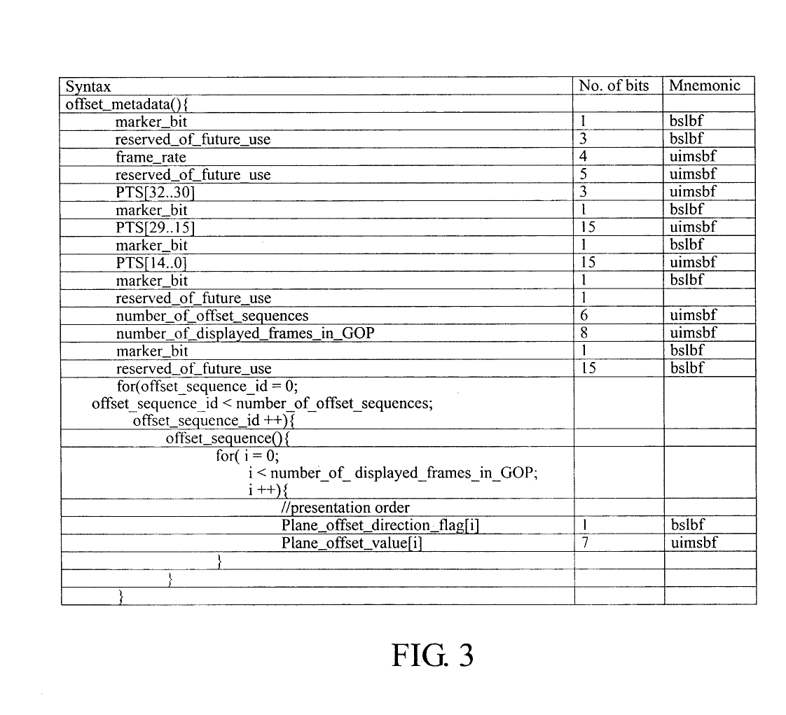

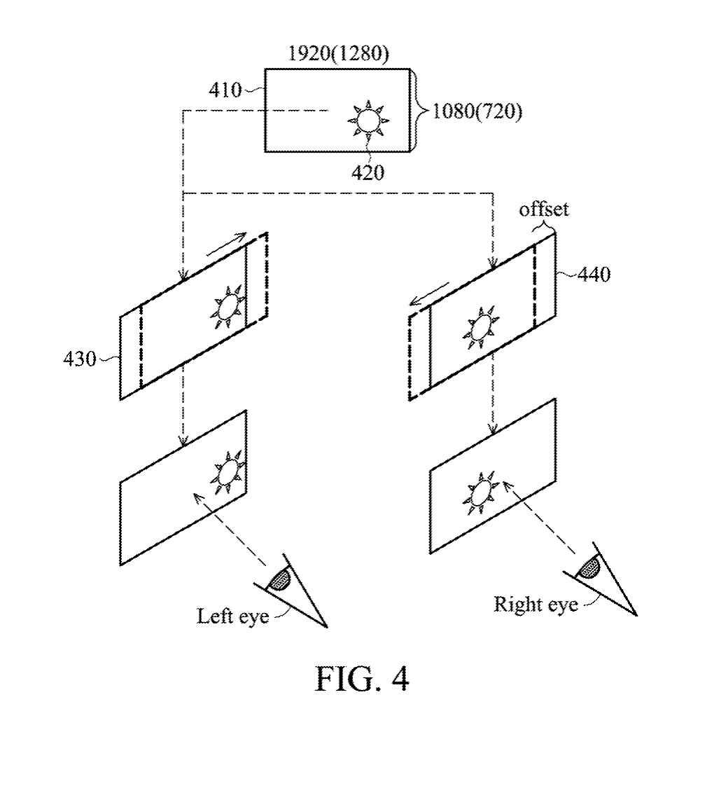

FIG. 3 illustrates the structure of offset metadata in the Blu-ray disc specification. Specifically, the offset metadata is a list of the offset sequence for the Presentation Graphics (PG) plane, Interactive Graphics (IG) plane, and BD-J Graphics Plane in the Blu-ray specification. The offset metadata is used to set offset values for the planes when the PG/Text Subtitles and/or IG/BD-J are presented during “stereoscopic output mode”. In an embodiment, the offset processing unit 220 applies offset information to the left/right-eye image, respectively, wherein the offset information comprises an offset value plane_offset_value indicating the offset distance referenced, and an offset direction flag plane offset_direction_flag indicating the direction for the offset. FIG. 4 illustrates a diagram of the conceptual image of plane shifting using the offset value. As illustrated in FIG. 4, when a user observes an object 420 (i.e. object 420 in the graphics plane 410) which may be presented on a screen, the left-eye image 430 is supposed to be horizontally right-shifted with a positive offset value by the offset processing unit 220, and the right-eye image 440 is supposed to be horizontally left-shifted with the positive offset value by the offset processing unit 220 before blending. On the contrary, the left-eye image 430 is supposed to be horizontally right-shifted with a negative offset value by the offset processing unit 220, and the right-eye image 440 is supposed to be horizontally left-shifted with the negative offset value by the offset processing unit 220. Specifically, the offset value represents the amount of shifting distance (i.e. in pixels), and the direction flag represents the direction of horizontally shifting the associated graphics plane (i.e. the sign number of the offset value). When the offset value plane offset_value is zero, the graphics plane 410 is not horizontally shifted before blending.

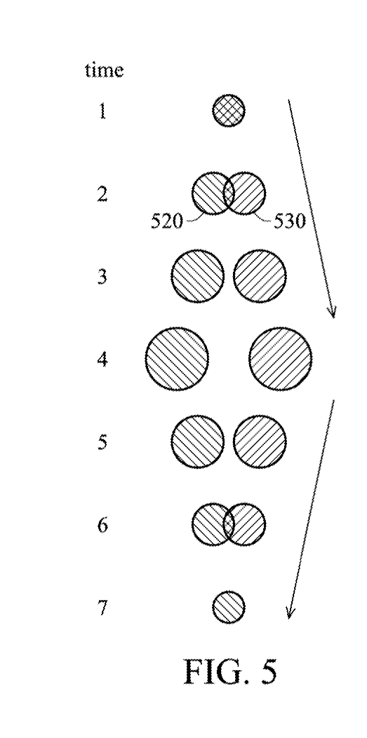

If an object in a stereoscopic image is getting closer to the user, the corresponding offset value of the left/right-eye image will also be adjusted accordingly to improve the stereoscopic viewing effect. The scaling unit 230 may scale (i.e. enlarge or shrink) the object according to the corresponding offset value. FIG. 5 illustrates a diagram for a moving object in the shifted stereoscopic image according to an embodiment of the invention. During the period from time 1 to 4, the object in the shifted stereoscopic image (i.e. the shifted left-eye image 520 and the shifted right-eye image 530) is getting closer to the user. During the period from time 4 to 7, the object is moving far away from the user. As illustrated in FIG. 5, the shifted stereoscopic image is enlarged by the scaling unit 230 gradually during the period from time 1 to 4. The shifted stereoscopic image is shrunk by the scaling unit 230 during the period from time 4 to 7. Specifically, the object in the shifted stereoscopic image is at the farthest position relative to the user at time 1, and the corresponding offset value of the shifted stereoscopic image may be very small. Thus, the shifted left-eye image 520 and the right-eye image 530 may be overlapped completely at time 1 since the offset value at time 1 may be too small to be ignored. At time 4, the object in the shifted stereoscopic image is at the closest position relative to the user, and the corresponding offset value of the shifted stereoscopic image may become larger. The scaling unit 230 will scale the shifted stereoscopic image according to the corresponding offset value. After scaling, the resulting stereoscopic image (i.e. resulting left-eye image and right-eye image) can be displayed on the display 100 by the scaling unit 230. It should be noted that the scaling unit 230 is capable of performing scaling to the objects in the shifted stereoscopic image or the shifted stereoscopic image itself.

In another embodiment, referring to FIG. 2 and FIG. 5, the scaling unit 230 can further scale the shifted stereoscopic image according to the corresponding offset value and the distance between the user and the display 100. Therefore, the user can sense that the objects are more realistic in the stereoscopic images of the application than those of prior technologies.

In yet another embodiment, the stereoscopic image processing apparatus 200 can process all the graphics data implemented by offset values. For example, Blu-ray three-dimensional graphics (BD-J), Interactive Graphics (IG, for menus), presentation graphics (PG, for subtitles) in the Blu-ray disc specification, or other three-dimensional applications using offset values can be applied in the stereoscopic image processing apparatus 200, but the invention is not limited thereto.

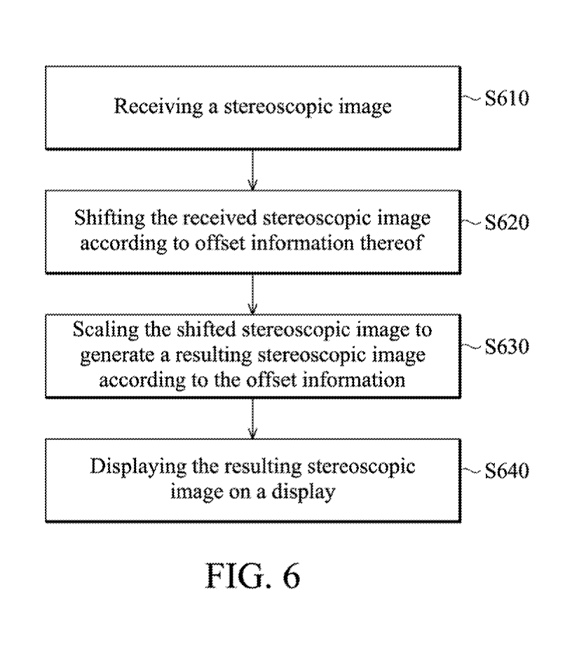

FIG. 6 illustrates a flow chart of the stereoscopic image processing method according to an embodiment of the invention. Referring to FIG. 2 and FIG. 6, in step S610, the display control unit 210 may receive a stereoscopic image (i.e. the left-eye image 211 and the right-eye image 212). In step S620, the offset processing unit 220 may shift the received stereoscopic image according to the offset information thereof. In step S630, the scaling unit 230 may scale the shifted stereoscopic image (i.e. the shifted left-eye/right-eye image) to generate a resulting stereoscopic image (i.e. the scaled left-eye/right-eye image) according to the offset information. In step S640, the scaling unit 230 may further display the resulting stereoscopic image on the display 100(i.e. display the scaled left-eye/right-eye image alternately). It should be noted that the steps S610, S620, and S630 can be executed sequentially or simultaneously (i.e. performed within a vertical sync pulse).

The stereoscopic image processing method of the invention, or certain aspects or portions thereof, may take the form of program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A stereoscopic image processing method, comprising:
receiving a stereoscopic image;
shifting the received stereoscopic image according to offset information thereof; and
scaling the shifted stereoscopic image to generate a resulting stereoscopic image according to the offset information.

2. The stereoscopic image processing method as claimed in claim 1, wherein the offset information is an offset value or an offset direction.

3. The stereoscopic image processing method as claimed in claim 1, wherein the stereoscopic image is a Presentation Graphics (PG) plane, an Interactive Graphics (IG) plane, a BD-J Graphics plane, or a combination thereof.

4. The stereoscopic image processing method as claimed in claim 2, wherein the stereoscopic image comprises a left-eye image and a right-eye image, and the offset value represents a number of pixels for horizontally shifting the left-eye image and the right-eye image respectively.

5. The stereoscopic image processing method as claimed in claim 4, wherein the offset direction represents a direction for horizontally shifting the left-eye image and the right-eye image respectively.

6. The stereoscopic image processing method as claimed in claim 2, wherein the stereoscopic image is enlarged when the offset value increases, and the stereoscopic image is shrunk when the offset value decreases.

7. The stereoscopic image processing method as claimed in claim 1, further comprising:
displaying the resulting stereoscopic image on a display, wherein the stereoscopic image is scaled according to the offset information and a distance between the display and a user.

8. A stereoscopic image processing apparatus, comprising:
an display control unit for receiving a stereoscopic image;
an offset processing unit for shifting the received stereoscopic image according to offset information thereof; and
a scaling unit coupled to the offset processing unit, for scaling the shifted stereoscopic image to generate a resulting stereoscopic image according to the offset information.

9. The stereoscopic image processing apparatus as claimed in claim 8, wherein the offset information is an offset value or an offset direction.

10. The stereoscopic image processing apparatus as claimed in claim 8, wherein the stereoscopic image is a Presentation Graphics (PG) plane, an Interactive Graphics (IG) plane, a BD-J Graphics plane, or a combination thereof.

11. The stereoscopic image processing apparatus as claimed in claim 9, wherein the stereoscopic image comprises a left-eye image and a right-eye image, and the offset value represents a number of pixels for horizontally shifting the left-eye image and the right-eye image.

12. The stereoscopic image processing apparatus as claimed in claim 11, wherein the offset direction represents a direction for horizontally shifting the left-eye image and the right-eye image.

13. The stereoscopic image processing apparatus as claimed in claim 12, wherein the scaling unit enlarges the stereoscopic image when the offset value increases, and shrinks the stereoscopic image when the offset value decreases.

14. The stereoscopic image processing apparatus as claimed in claim 8, wherein the scaling unit further displays the resulting stereoscopic image on a display, and scales the stereoscopic image according to the offset information and a distance between the display and a user.

15. A non-transitory computer-readable medium with an executable program stored thereon, wherein the program instructs a processor to perform the following steps:
receiving a stereoscopic image;
shifting the received stereoscopic image according to offset information thereof; and
scaling the shifted stereoscopic image to generate a resulting stereoscopic image according to the offset information.

16. The non-transitory computer-readable medium as claimed in claim 15, wherein the offset information is an offset value or an offset direction.

17. The non-transitory computer-readable medium as claimed in claim 15, wherein the stereoscopic image is a Presentation Graphics (PG) plane, an Interactive Graphics (IG) plane, a BD-J Graphics plane, or a combination thereof.

18. The non-transitory computer-readable medium as claimed in claim 17, wherein the stereoscopic image comprises a left-eye image and a right-eye image, and the offset value represents a number of pixels for horizontally shifting the left-eye image and the right-eye image.

19. The non-transitory computer-readable medium as claimed in claim 18, wherein the offset direction represents a direction for horizontally shifting the left-eye image and the right-eye image.

20. The non-transitory computer-readable medium as claimed in claim 16, wherein the stereoscopic image is enlarged when the offset value increases, and the stereoscopic image is shrunk when the offset value decreases.

21. The non-transitory computer-readable medium as claimed in claim 15, wherein the processor further executes the following step:
displaying the resulting stereoscopic image on a display, wherein the stereoscopic image is scaled according to the offset information and a distance between the display and a user.
